(19) United States
(12) Patent Application Publication
(10) Pub. No.: US 2006/0081806 A1
(43) Pub. Date: Apr. 20, 2006

(54) Solenoid valve and a solenoid assembly

(76) Inventor: Ingo Doubrawa, Joinville (BR)

Correspondence Address: TRASK BRITT, P.O. BOX 2550, SALT LAKE CITY, UT, 84110, US

(21) Appl. No.: 11/223,894

(22) Filed: Sep. 9, 2005

(30) Foreign Application Priority Data
Sep. 10, 2004 (BR) P10403883-5

(51) Int. Cl. F16K 51/00

(52) U.S. Cl. 251/285

(57) ABSTRACT

The present invention relates to a bistable-type solenoid valve, composed by a valve assembly including a valve seat and a valve-seat orifice and a solenoid assembly including a coil that houses, at least partly, a valve member displaceable by an electromagnetic force generated by a coil, a magnet and an adjustment element adjacent the magnet. The valve member, upon being displaced, travels a distance in the direction of the valve-seat orifice until said orifice is obstructed, thus causing the valve to close, or in the opposite direction so as to clear said orifice, thus causing the valve to open. The adjustment element of the solenoid assembly adjusts the distance, thus enabling one to compensate the variations of dimensions of the parts that compose the solenoid assembly, so that such variations will not impair the good operation of the valve.

### BACKGROUND OF THE INVENTION

This application claims priority to Brazilian Patent Application No. PI0403883-5, filed Sep. 10, 2004, and incorporates the same herein by reference in its entirety.

1. Field of the Invention

The present invention relates to a solenoid valve, and more specifically to a bistable-type solenoid valve, particularly designed for selectively enabling the passage and interruption of passage of a flow through a tubing in which it is installed. The invention further relates to a solenoid assembly, particularly designed for use on a solenoid valve.

2. Description of the Prior Art

Some types of bistable solenoid valves used for controlling fluid flow are known.

Conventional solenoid valves basically comprise a valve unit and a solenoid unit. The valve unit is formed, for instance, by a valve body, a flow inlet, a flow outlet and a valve seat. On the other hand, the solenoid unit is provided with a coil (which generates momentary electromagnetic force), a magnet, a valve element, which moves under the influence of the electromagnetic force, opening and closing the valve, and other components.

Bistable valves are those that have two clearly distinguished states: open and closed.

The change of state of a conventional bistable solenoid valve results from the interruption of the electromagnetic field generated by the coil and the other components of the solenoid unit. The electromagnetic field generated by the coil results from an electric pulse applied to its terminals with polarity inversion for opening and closing the system, which acts only during movement of the valve element. The pulse is applied only at the moments when one desires alteration of the state of the valve from open to closed and vice-versa.

It is well to point out that, in the known bistable solenoid valves, the electric pulse applied to the coil should be sufficient for generating an electric magnetic field capable of moving the valve element according to the constructive specifications of the valve, that is to say, this electric pulse may not be sufficient, for instance, to generate a magnetic field capable of moving the valve element through a distance much longer than that foreseen in the design for the valve.

Therefore, in case of wear and/or manufacture with less control of dimensional tolerance of the components, the magnetic field generated by the electric pulse may not be sufficient to enable the operation of the valve, or still in some cases it may be excessive, which causes a higher and unnecessary consumption of electricity.

In a very simple manner, the functioning of solenoid valves of the prior art can be described as follows.

In a first situation, a valve element that is housed in a sleeve of the solenoid assembly moves in an axial direction, with the actuation of the electromagnetic field generated by a coil. The electromagnetic force, which is generated when an electric pulse is applied to the coil terminals, drives the valve element axially towards the orifice of the valve-assembly seat. In other words, in this hypothesis the valve is closed.

The contrary movement of the valve element is caused, for instance, by application of en electric pulse of inverted polarity to the coil terminals. In this hypothesis, the valve opens.

In order to obtain a solenoid valve with less consumption of electric energy, one should optimize the system so that the movement of the valve element will have the shortest course possible, contemplating all the dimensional variations of the valve. This is exactly what the present invention provides.

The course of the valve element is a distance traveled by the valve element to obstruct and clear the orifice of the valve seat, that is to say, to close and open the valve. This distance, in turn, depends upon the constructive characteristics of the valve, that it, dimensions of the parts that constitute it.

In the valves existing on the market, in order to optimize the consumption of energy and guarantee a good functioning, it is necessary to size the parts precisely. Any variation in the dimensions of the parts will influence the distance to be traveled by the valve element, consequently requiring application of an electric pulse greater than originally designed, often causing a greater consumption of energy, which configures a situation of bad operation of the valve. If the electric pulse is not increased, the valve will stop operating satisfactorily.

In addition, the natural wear of the component parts, which is reflected on their dimensions, may cause the same problems cited above.

This situation is more serious when it is known that in traditional solenoid valves, variations in dimension of the parts often occur, which affects the quality, the manufacture course and, consequently, the price itself of the valves. Moreover, after the valve has been mounted, there is no way of correcting the variations of the parts that compose it, which makes it impossible to carry out a posteriori adjustments, which are very important when, for instance, the valve shows wear of these components due to the operation time.

The present invention solves these problems by means of a solenoid valve that allow the variations of the parts to be compensated by regulating the already-mounted solenoid assembly.

A first objective of the present invention is to provide a solenoid valve with lower consumption of energy, enabling, for instance, the use of batteries for actuating it.

A second objective of the present invention is to provide a solenoid valve that enables one to adjust precisely the distance traveled by the valve element to effect the opening/closing of the valve in function of the variations in size of the parts thereof.

A third objective of the present invention is to provide a solenoid valve that enables a low manufacture cost.

A fourth objective of the present invention is to provide a solenoid valve that enables one to compensate the wear of the parts/components thereof.

A fifth objective of the present invention is to provide a solenoid assembly that exhibits lower consumption of energy and enables one to adjust precisely the distance traveled by the valve element to effect opening/closing of the valve in function of the variations in dimensions of its parts, to correct variations that were not foreseen in the design thereof after it has been mounted and to compensate the wear of its parts/components.

### BRIEF SUMMARY OF THE INVENTION

The present invention achieved these objectives and others by means of a solenoid valve comprising:
a valve assembly including a valve seat and at least one orifice in the valve seat and a solenoid assembly comprising a coil that houses, at least partly, a valve member and at least one magnet. The valve member is axially displaceable by an electromagnetic force generated by the coil, traveling a distance in the direction of the orifice of valve seat, until said orifice is obstructed, or in the opposite direction, thus clearing the orifice. The solenoid assembly further has an adjustable adjustment element for adjusting the distance axially.

The valve member, upon obstructing the orifice of valve seat, causes the valve to close. In the opposite direction the valve member, upon clearing the orifice of the valve seat, causes the valve to open.

It should be pointed out that the constructive shape referring to the hydraulic function of the solenoid valve already exists on the market since long ago and is not determining for the understanding of the present invention. For this reason, this constructive shape is not defined in this document.

The objectives of the present invention are further achieved by means of a solenoid assembly, particularly for use on a solenoid valve comprising a valve assembly including a valve seat and at least one orifice of valve seat, comprising a coil that houses, at least partly, a valve member and at least one magnet, the valve member being axially displaceable by an electromagnetic force generated by the coil, traveling a distance in the direction of the orifice of valve seat, until said orifice is obstructed, or in the opposite direction, thus clearing the orifice. The assembly further has an adjustable adjustment element for adjusting the distance axially.

### BRIEF DESCRIPTION OF THE SEVERAL VIEWS OF THE DRAWINGS

The present invention will now be described in greater detail with reference to an embodiment represented in the drawings. The figures show:

FIG. 1 a top view of the solenoid valve of the present invention, showing the AA′ sectional region;

FIG. 2 is a longitudinal section view, along the line AA′, of the solenoid valve of FIG. 1, in open position, illustrating the valve assembly and the solenoid conjunction;

FIG. 3 is a detail view of the solenoid valve in open position illustrated in FIG. 2;

FIG. 4 is a longitudinal-section view, along line AA′, of the solenoid valve of FIG. 1 in closed position illustrating the valve assembly and the solenoid assembly; and

FIG. 5 is a detail view of the solenoid valve in closed position illustrated in FIG. 4.

### DETAILED DESCRIPTION OF THE INVENTION

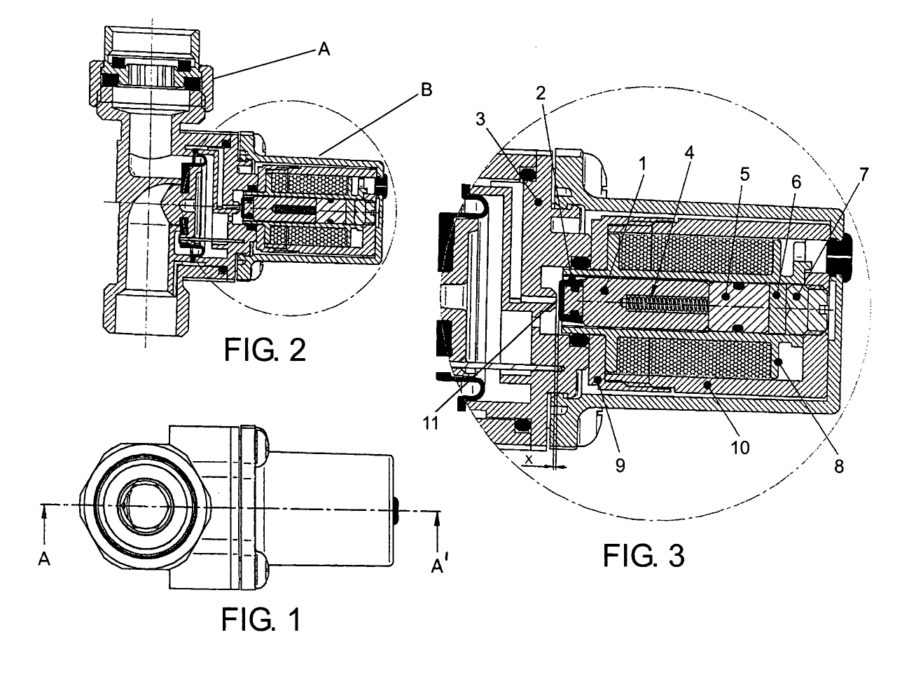

A preferred embodiment of the solenoid valve of the present invention, among so many others, is illustrated in FIGS. 1 to 5.

By preference, the solenoid valve of the present invention is designed for use in a tubing that transports fluids, preferably in liquid form. However, it may be used in any other necessary or desirable situation. The constructive shape referring to the hydraulic function of the solenoid valve already exists on the market since long ago and is not determining for the understanding of the present invention, so that it will not be defined herein.

FIG. 1 shows a top view of a preferred embodiment of the bi stable solenoid valve of the present invention, showing the AA′ section region. The components of the valve are better viewed in FIGS. 2 to 5.

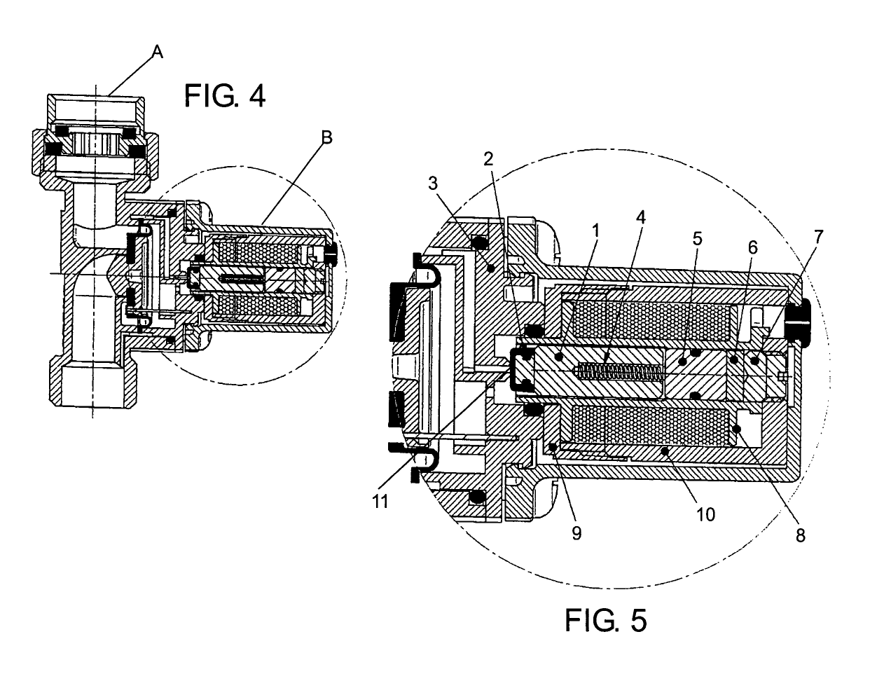

FIGS. 2 and 4 show a longitudinal-section view along line AA′ of a preferred embodiment of the solenoid valve of the present invention in open and closed positions, respectively.

The solenoid valve comprises any valve assembly or unit A including a valve seat 3 and at least one valve-seat orifice 11; and a solenoid assembly or unit B including a coil 8, which loges, at least partly, a valve member 1 (also called shaft) by preference substantially cylindrical (which is axially displaceable by an electromagnetic force generated by the coil 8, traveling a determined distance in the direction of the valve-seat orifice 11, until said orifice is obstructed, or in the opposite direction so as to clear said orifice), at least one stop 5, at least one magnet 6 and an adjustment element 7 adjacent the magnet 6, adjustable for axial adjustment of the distance traveled by the member 1.

Initially, it should be noted that the valve seat 3 is any seat that is functional and will not be described in greater detail, since it is widely known and its particularities are not included in the scope of the accompanying claims.

The valve body 1, upon obstructing the valve-seat orifice 11, causes the valve to close, this situation being illustrated in FIGS. 4 and 5. In the opposite direction, upon clearing the valve-seat orifice 11, the valve member 1 causes the vale to open, as illustrated in FIGS. 2 and 3. The movement of this member 1 will be described in detail later.

In order to enable the valve to close correctly with complete tightness when the valve member 1 approaches the valve-seat orifice 11 and obstructs it, this member 1 preferably has a sealing cover 2 of a resilient material (such as, for example, a polymeric material, or any other functional material, in any configuration that is functional) that is located at its first end facing the orifice 11 and that deforms upon touching it. In this way, one prevents any amount of fluid from passing through the orifice 11, ensuring that the valve will remain perfectly closed. However, one may foresee a bistable valve, in which, due ton the manufacture tolerance of its components (mainly the orifice 11 and the member 1), the sealing cover 2 is not necessary.

Further preferably, the member 1 has a substantially cylindrical and concentric non-through opening facing a second end thereof, opposed to the first one, at which the sealing cover 2 is located. Inside this opening, at least one coil spring 4 (or any other functional resilient element such as an elastomer) is provided, the function of which will be described in detail later. The spring 4 expands when the valve member 1 is displaced in the direction of the valve-seat orifice 11 and is compressed when the valve member 1 moves in the opposite direction away from it, that is to say, when the valve closes and opens, respectively.

Axial and adjacent the second end of the member 1, there is a stop 5, preferably cylindrical and made of a ferromagnetic material, and, further axial and adjacent to it, a magnet 6 is provided.

Since the stop 5 is constituted by a ferromagnetic element, it can conduct the magnetic flux from the magnet 6, until the latter reaches the member 1 (which will be explained later).

Further preferably, the coil 8 is encapsulated by a pair of metallic cover 9, 10, forming what is called a “coil assembly.” Such an arrangement provides an effective utilization of the actuating magnetic forces.

The great innovation of the bistable solenoid valve of the present invention lies in the existence of at least one adjustment element 7 (which preferably is in the form of a screw but may have any other functional configuration), the prime function of which is to regulate the maximal distance between the member 1 and the orifice 11. In this way, it becomes possible to correct variations caused by tolerance deviations during the manufacture of the valve, wear of the components, wrong mounting, etc. In other words, the adjustment element 7 enable one to compensate the variations in dimensions of the parts that compose the solenoid assembly B.

Since this is a bistable solenoid valve, it remains in a stable position (open or closed) until its state is altered, which is achieved by means of an electric pulse applied to the coil, which generates a magnetic field necessary and sufficient for moving the valve member 1. The electric pulse may be originated in any way, as for instance, automatically or even manually.

When the valve is open, the magnet 6, the magnetic flux of which is conducted by the stop 5, keeps the valve member 1 retracted, which remains in contact with the stop 5. In order for this situation to occur, the spring 4 is compressed and the magnetic attraction force of the magnet 6 must be higher than the elastic force exerted by the spring 4, which is compressed and tends to move the member 1 away from the stop 5. In this way, the first end of the member 1, and particularly the sealing cover 2, is not in contact with the valve seat orifice 11. This situation may be visualized with the aid of FIGS. 2 and 3.

In order for the valve to close, it is necessary to apply a brief electric pulse to the coil 8, generating a magnetic field that will move the member 1 toward the valve seat orifice 11. This brief magnetic field, plus the constant elastic force that the spring 4 exerts trying to move the member 1 away from the stoop 5, surpasses the magnetic flux produced by the magnet 6, moving the member away from the stop. Then, the magnetic field stops existing, but the elastic for of the spring 4 moves the member 1 until its first end touches the valve seat orifice 11, opening the valve. In the next moment, the attraction force exerted by the magnet 6 has decreased (since it is inversely proportional to the distance between the two bodies, which has increased) and becomes lower than the elastic force exerted by the spring 4, since the member has already moved away from the stop 5.

Therefore, the spring 4 causes the advance of the valve member 1, keeping it in the position of obstruction of the valve seat orifice 11, as can be seen in FIGS. 4 and 5. The member 1 remains in this position until a new electromagnetic force in the reversed direction causes it to move in the opposite direction.

As can be seen in FIG. 3, the course of movement of the valve member 1 is illustrated under reference X and corresponds to the distance between the first end of the member 1 (independently of the existence of the sealing cover 2) and the valve seat orifice 11, when the valve is open (that is to say, when the member 1 is in contact with the stop 5, attracted by the magnetic flux of the magnet 6).

When a second brief electric pulse is applied to the coil 8 and generates a magnetic field in the reversed direction, the latter will move the valve member 1 away from the orifice 11 and towards the stop 5. For this purpose, this brief field should surpass the elastic force exerted by the spring 4, since the movement of the member 1 causes compression thereof. As soon as the member 1 comes quite close to the stop, the attraction force exerted by the magnet 6 surpasses the elastic force exerted by the spring 4 and it is kept resting against the stop. At this instant, the brief magnetic field does not exist any more. In this way, the valve seat orifice 11 is cleared and the valve opens (again as illustrated in FIGS. 2 and 3).

Therefore, the magnetic fields are necessary only to initiate the change in state of the valve 1, which is complemented and maintained stable by the relationship between the elastic force exerted by the spring 4 and the magnetic attraction force exerted by the magnet 6.

The intensity of the electric pulse and, consequently, of the electromagnetic fields generated on the coil 8 are determined according to the elastic constant of the spring 4, of the attraction force exerted by the magnet and, above all, by the distance X which the member 1 has to travel for opening/closing the valve 1. More generically, the magnitude of the electromagnetic force act on the elements of the solenoid assembly B is determined by the magnitude of the magnetic field generated by the coil 8 and its interaction with the parts of the solenoid assembly B. In this way, the dimension of these parts will have direct influence on determining the magnetic field to be generated.

With the existence of the adjustment element 7, it is possible to alter the position of the member 1 when it is away from the orifice 11 (open valve). For this purpose, suffice it to screw it, and then the assembly formed by the member 1, stop 5 and magnet 6 will move radially. In this way, it is possible to restore the ideal distance X for the correct operation of the valve, even when it has been altered according to the wear on the valve components, tolerance deviations during the manufacture of the valve, wrong mounting, etc, compensating variations in the dimensions of the parts that compose the solenoid assembly B.

Additionally, it is important to mention that, in the valve illustrated in FIGS. 1 to 5, the regulation of the adjustment element is simple and easy, since it is easily accessed from the free end of the solenoid assembly B.

It is pointed out that the distance X is of great influence in trying to minimize the consumption of energy and to ensure a good operation. This distance is directly influenced by a sum of measurements and their specific variations in the design, occurred in the manufacture of the parts numbered from 1 to 11, which have a high manufacture cost due to the accuracy and repeatability required.

With the introduction of the adjustment element 7, the variation in dimensions of the other parts of the assembly is compensated by an adjustment that is effected after mounting the solenoid assembly. In this way, one achieves an optimal accuracy and a better quality with the cost being quite lower than that of the method of obtaining traditional solenoid valves, which is based on the manufacture of very precise parts and does not foresee the opportunity of correcting possible variations after mounting the valve.

By preference, the solenoid assembly B is easily detachable from the valve seat, so as to facilitate its maintenance, and the regulation of the adjustment element, since it may require correction because of wear of its components. The assembly B in itself is an invention and is protected n the accompanying claims.

Generically, the solenoid assembly B is particularly designed for use on a solenoid valve comprising a valve assembly A including a valve seat 3 and at least one valve seat orifice 11, and comprises the coil 8, which houses at least partly the valve member 1 and at least one magnet 6. As already mentioned before, the valve member 1 is axially displaceable by an electromagnetic force generated by the coil 8, traveling a distance X in the direction of the valve seat orifice 11 until said orifice is obstructed, or in the opposite direction, clearing said orifice, and further has an adjustment element 7 adjustable for axial adjustment of the distance X, which is the great difference and innovation of this invention.

It should be understood that the solenoid valve and its components described above, as well as the solenoid assembly and its components, are only some of the embodiments that could exist, and that the scope of the present invention embraces other possible variations, being limited only by the contents of the accompanying claims, which include the possible equivalents.

What is claimed is:

1. A solenoid valve comprising:
a valve body including a valve seat and at least one valve-seat orifice; and
a solenoid assembly comprising a coil, which houses, at least partly, a valve member and at least one magnet;
the valve member being axially displaceable by an electromagnetic force generated by the coil, traveling a distance in the direction of the valve-seat orifice until said orifice is obstructed, or in the opposite direction so as to clear said orifice;
the valve being characterized in that the solenoid assembly further has an adjustment element for adjusting the axial distance.

2. A solenoid valve according to claim 1, characterized in that it further comprises a stop arranged between the valve member and the magnet.

3. A solenoid valve according to claim 1, characterized in that the valve member has a first end facing the valve-seat orifice, covered by a sealing cover.

4. A solenoid valve according to claim 1, characterized in that the member has a substantially cylindrical and concentric non-through opening facing a second end opposite the first one, inside which at least one coil spring is provided.

5. A valve according to claim 1, characterized in that the coil is encapsulated by a pair of metallic covers.

6. A valve according to claim 1, characterized in that the adjustment element is adjacent the magnet.

7. A valve according to claim 1, characterized in that the adjustment element is a screw.

8. A solenoid assembly, particularly for use on a solenoid valve comprising a valve assembly including a valve seat and at least one valve-seat orifice, the assembly comprising a coil that houses, at least partly, a valve member and at least one magnet, the valve member being axially displaceable by an electromagnetic force generated by the coil, traveling a distance in the direction of the valve-seat orifice until said orifice is obstructed, or in the opposite direction so as to clear said orifice, the assembly being characterized by further having an adjustment element for adjusting the axial distance.

9. An assembly according to claim 8, characterized in that it further comprises a stop arranged between the valve member and the magnet.

10. An assembly according to claim 8, characterized in that the valve member has a first end facing the valve-seat orifice, covered by a sealing cover.

11. An assembly according to claim 8, characterized in that the member has a substantially cylindrical and concentric non-through opening facing a second end thereof opposite the first one, inside which at least one coil spring is provided.

12. An assembly according to claim 8, characterized in that the coil is encapsulated by a pair of metallic covers.

13. An assembly according to claim 8, characterized in that the adjustment element is adjacent the magnet.

14. An assembly according to claim 8, characterized in that the adjustment element is a screw.
